(19) United States
(12) Patent Application Publication
(10) Pub. No.: US 2007/0024517 A1
(43) Pub. Date: Feb. 1, 2007

(54) Antenna

(75) Inventor: Hideaki Shimoda, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/490,121

(22) Filed: Jul. 21, 2006

(30) Foreign Application Priority Data
Jul. 26, 2005 (JP) P2005-216410

(51) Int. Cl. H01Q 9/28

(52) U.S. Cl. 343/795; 343/700 MS

(57) ABSTRACT

An antenna has a base and an antenna element in contact with the base. The product of the relative permittivity of the base and the relative permeability of the base varies with a negative gradient with respect to the frequency of the radio waves transmitted by the antenna element or received by the antenna element. The negative-gradient variation of the product acts to offset the frequency-dependent variation in the wavelength.

### BACKGROUND OF THE INVENTION

1. Field of the Invention

The present invention relates to an antenna for transmitting or receiving radio waves.

2. Related Background Art

A variety of antennas with an antenna element on a base are known. For example, Japanese Patent Application Laid Open No. 2000-82914 discloses a microstrip antenna having a base made of a magnetic material and Japanese Patent Application Laid Open No. H9-121114 discloses a microstrip antenna having a base made of a dielectric material. Further, Japanese Patent Applications Laid Open Nos. 2004-363859 and 2002-374122 disclose antennas having a base made of a dielectric or magnetic material.

It is an important object to reduce the physical dimension of antennas to be set in small devices such as mobile devices. In order to obtain a small antenna, it is effective to dispose an antenna element on a base with a high permittivity or high permeability. However, in this case, there is a problem that the operating frequency bandwidth is narrow. On the other hand, if the permittivity or permeability of the base is reduced to broaden the operating frequency bandwidth, the antenna becomes larger.

### SUMMARY OF THE INVENTION

An object of the present invention is to broaden the operating frequency bandwidth of antennas while suppressing the enlargement thereof.

An antenna in accordance with the invention comprises a base having a relative permittivity and a relative permeability, and a first antenna element in contact with the base. The first antenna element is adapted to transmit or receive a radio wave having a frequency. The product of the relative permittivity and the relative permeability varies with a negative gradient with respect to the frequency of the radio wave.

The product of the relative permittivity and the relative permeability does not always need to vary with a negative slope with respect to all the frequencies and may instead vary with a negative slope within a certain frequency region. If this antenna is used in a frequency bandwidth containing at least part of the frequency region, it is possible to broaden the operating frequency bandwidth.

More preferably, the product of the relative permittivity and the relative permeability is inversely proportional to the square of the frequency.

In one embodiment of the invention, the base may include a plate having an upper face and a lower face. The first antenna element may have a conductor film provided on the upper face of the base. The antenna may further comprise a second antenna element having another conductor film in contact with the lower face of the base, and may operate as a dipole antenna.

In another embodiment of the invention, the base may include a plate having an upper face and a lower face. The first antenna element may have a conductor film provided on the upper face of the base. The antenna may further comprise a grounding conductor in contact with the lower face of the base, and may operate as a patch antenna.

The present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic perspective view of an antenna of the first embodiment;

FIG. 2 shows an example of the frequency characteristic of the permeability and the permittivity of the base; and

FIG. 3 schematically shows an antenna of the second embodiment.

### DESCRIPTION OF THE PREFERRED EMBODIMENTS

The preferred, embodiments of the present invention will be described below in greater detail with reference to the accompanying drawings. To facilitate understanding, identical reference numerals are used, where possible; to designate identical or equivalent elements that are common to the embodiments, and, in subsequent embodiments, these elements will not be further explained.

First Embodiment

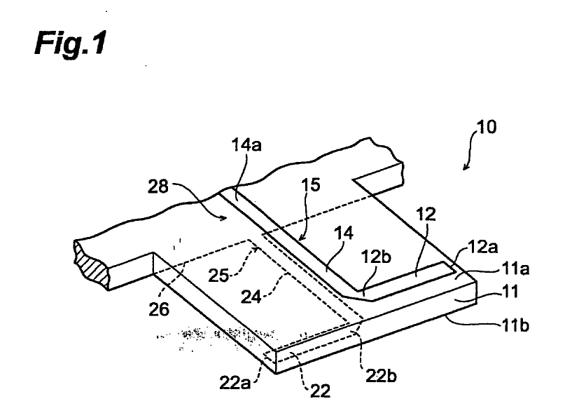

FIG. 1 is a schematic perspective view showing an antenna of the first embodiment of the present invention. The antenna 10 is called a printed dipole antenna and is configured of a base 11 shaped in a flat plate, and thin film electric conductors 15 and 25 that are in contact with the base 11. A part 12 in the conductor 15 and a part 22 in the conductor 25 are antenna elements for transmitting or receiving radio waves. Hereinafter, the antenna 10 will be described as a transmitting antenna, and the antenna elements 12 and 22 will be called transmitting elements. However, the antenna 10 naturally has an ability to receive radio waves, and therefore the antenna elements 12 and 22 are also receiving elements.

The base 11 has an upper face 11a and a lower face 11b that are flat and parallel to one another. The conductor 15 is provided on the upper face 11a, and contains a first transmitting element 12 and a first electric supply line 14. Both the transmitting element 12 and the supply line 14 are shaped in a strip. The transmitting element 12 has an open, distal end 12a, and a proximal end 12b connected to the supply line 14. The supply line 14 extends substantially perpendicular to the transmitting element 12.

On the other hand, the conductor 25 is provided on the lower face 11b of the base 11, and contains a second transmitting element 22, a second electric supply line 24, and a grounding electrode 26. Both the transmitting element 22 and the supply line 24 are shaped in a strip. The transmitting element 22 has an open, distal end 22a, and a proximal end 22b connected to the supply line 24. The supply line 24 extends substantially perpendicular to the transmitting element 22.

The first transmitting element 12 and the second transmitting element 22 extend on the same axis in inverse directions, and constitute one dipole antenna element. The sum of the lengths of the transmitting elements 12 and 22, that is, the distance from the distal end 12a of the transmitting element 12 to the distal end 22a of the transmitting element 22 is substantially equal to a half wavelength.

The first and second supply lines 14, 24 are disposed so as to overlap with the base 11 interposed therebetween. The grounding electrode 26 is connected to one end of the supply line 24 located away from the Knitting element 22, and has a sufficiently wide a part 14a in the first supply line 14 disposed opposite the grounding electrode 26 constitutes a microstrip line 28 together with the grounding electrode 26.

As mentioned above, the transmitting elements 12, 22 can also be used to receive radio waves as well as to transmit radio waves. When electrical power is supplied to the transmitting elements 12, 22 via the microstrip line 28 and the supply lines 14, 24, the electrical power is transmitted as radio waves from the transmitting elements. Conversely, when the transmitting elements 12, 22 receive arriving radio waves, the radio waves are converted into electrical power, which is outputted via the supply lines 14, 24 and the microstrip line 28.

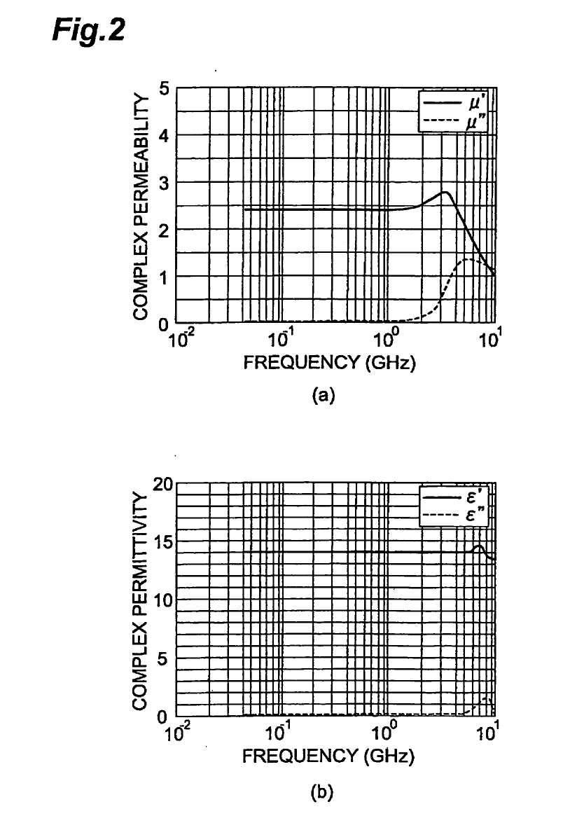

In this embodiment, a hexagonal-system ferrite with the characteristic shown in FIG. 2 is used as a material of the base 11. Here, FIG. 2 shows the frequency characteristic of the permeability and permittivity of the hexagonal-system ferrite. A hexagonal-system ferrite is a magnetic material containing iron oxide as the main component, but also has the properties of a dielectric. In FIG. 2(a), μ′ and μ″ represent the real part and imaginary part, respectively, of the complex number representation of permeability μ. Here, permeability μ is denoted by μ=μ′−μ″. The magnitide of permeability μ is equal to (μ′²+μ″²)^{1/2}. Further, in FIG. 2(b), ε′ and ε″ represent the real part and the imaginary part, respectively, of the complex number representation of permittivity ε. Here, permittivity ε is denoted by ε=ε′+jε″. The magnitude of permittivity ε equals (ε′²+ε″²)^{1/2}.

As shown in FIG. 2(a), μ′ is substantially constant for magnetic waves of low frequencies. However, at sufficiently high frequencies, μ′ drops as the frequency increases, that is, varies with a negative gradient (differential coefficient) with respect to the frequency. μ″ is 0 at low frequencies; however, at high frequencies, μ″ varies with a negative gradient with respect to the frequency. As a result, in a sufficiently high frequency region, the permeability μ varies with a negative gradient with respect to the frequency. Meanwhile, ε′ and ε″ are substantially constant irrespective of the frequency. Therefore, in a high frequency region, the product of the permeability and the permittivity of the base 11 varies with a negative gradient with respect to the frequency.

As mentioned in the thirteenth paragraph of Japanese Patent Application Laid Open No. 2000-82914 above, conventionally, it has been considered desirable to use a material that suppresses a drop in the permeability at high frequencies for a base of an antenna. However, the inventor discovered that the operating frequency bandwidth of the antenna can be increased by using the characteristic that the permeability or permittivity drops with a negative gradient with respect to the frequency. This fact will be described in detail below.

In general, the length of the antenna element is likely to be larger with increase of the wavelength of radio waves to be tansmitted or received by the antenna element. Therefore, the antenna element can be shorter as the wavelength decreases, and accordingly the antenna can be made small. The wavelength of radio waves transmitted or received by the antenna element is influenced not only by the frequency of the radio waves but also by the permittivity and permeability of the base which is in contact with the antenna element More specifically, the wavelength of the radio waves is expressed by the following equation:
λ=c/f=c₀/f\sqrt{εr×μr} (1).
Here, λ is the wavelength of the radio waves, c is the speed of light in the base 11, f is the frequency of the radio waves, c₀ is the speed of light in a vacuum, εr is the relative permittivity of the base 11, and μr is the relative permeability of the base 11. The relative permittivity is the ratio of the permittivity of the base 11 to the permittivity of a vacuum and the relative permeability is the ratio of the permeability of the base 11 to the permeability of a vacuum.

As mentioned earlier, the product of the permittivity and the permeability and the product of the relative permittivity and the relative permeability of the base 11 vary with a negative gradient with respect to the frequency f in a high frequency region. Since εr×μr decreases with increase of frequency f, the variation in wavelength λ according to frequency f is suppressed as is clear from equation (1). Thus, the variation of the product of the relative permittivity and the relative permeability with a negative gradient serves to offset the variation in the wavelength according to the frequency. Accordingly, the frequency-dependent variation in the wavelength becomes slow, and therefore it is possible to broaden the frequency bandwidth in which the antenna 10 can operate (that is, in which the antenna 10 can be used), and also possible to suppress the enlargement of the antenna 10.

It is preferable that the product of the relative permittivity and the relative permeability of the base 11 is inversely proportional to the square of the frequency. In this case, as is clear from equation (1), the wavelength is kept constant even when the frequency changes. This means that the favorable operating state of the antenna is maintained even when the frequency varies. Therefore, the operating frequency bandwidth of the antenna can be broadened still further.

As shown in equation (1), when the product of the relative permittivity and the relative permeability of the base 11 is large, the wavelength becomes short, and therefore the transmitting elements 12, 22 can be correspondingly shortened and the antenna 10 can be made smaller. In order to reduce the size of the antenna 10 so that the antenna 10 can be implemented in a portable device, the product of the relative permittivity and the relative permeability of the base 11 is preferably not less than 9 in the operating frequency bandwidth of the antenna 10, and more preferably not less than 25. This condition is satisfied by a hexagonal-system ferrite the characteristic shown in FIG. 2.

Second Embodiment

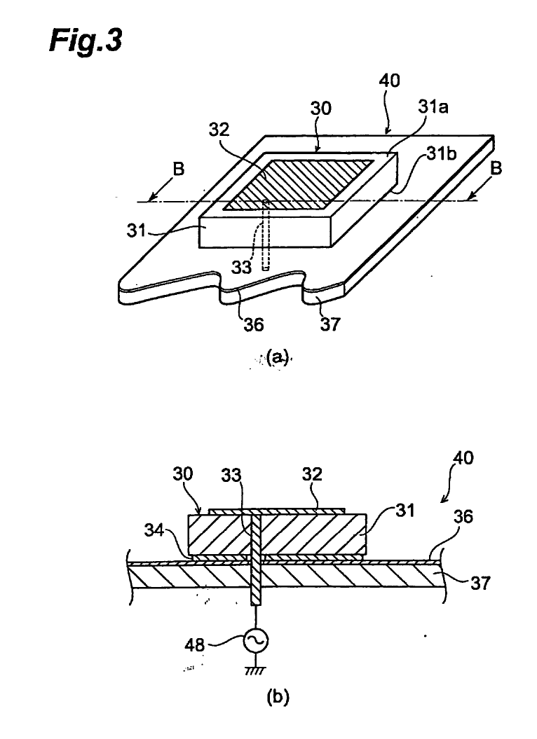

FIG. 3 shows the configuration of an antenna device according to the second embodiment of the present invention. FIG. 3(a) is a perspective view showing the antenna device, and FIG. 3(b) is a cross-sectional view taken along the line B-B in FIG. 3(a). An antenna device 40 has a patch antenna 30 and a substrate 37 on which the patch antenna 30 is mounted. One principal face (upper face) of the substrate 37 is covered by a grounding electrode 36 on which the patch antenna 30 is disposed.

The patch antenna 30 is configured of a base 31 shaped in a flat plate, a thin film electric conductor 32 in contact with the upper face of the base 31, an electric supply conductor 33 that penetrates the base 31, and a thin film grounding conductor 34 in contact with the lower face of the base 31. The conductor 32 is an antenna element for transmitting or receiving radio waves. Hereinafter, the patch antenna 30 will be described as a transmitting antenna, and the antenna element 32 will be called a transmitting element However, the patch antenna 30 naturally has an ability to receive radio waves, and therefore the antenna element 32 is also a receiving element.

The base 31 has an upper face 31a and a lower face 31b that are flat and parallel to one another. The transmitting element 32 and the grounding conductor 34 are provided on the upper face 31a and the lower face 31b, respectively. The transmitting element 32 has a rectangular planar shape. The grounding conductor 34 is in contact with the grounding electrode 36 and is therefore at ground potential.

The supply conductor 33 extends substantially perpendicularly from the transmitting element 32 and penetrates the base 31, grounding conductor 34, grounding electrode 36, and substrate 37. One end of the supply conductor 33 is connected to the transmitting element 32 and the other end protrudes from the lower face of the substrate 37. The other end is connected to a power supply 48 for producing an AC voltage. When the power supply, 48 applies a high frequency voltage between the transmitting element 32 and the grounding connector 34 via the supply conductor 33, radio waves are transmitted from the transmitting element 32.

Like the base 11, the base 31 is made of a hexagonal-system ferrite with the characteristic shown in FIG. 2. Therefore, the product of the relative permittivity and relative permeability of the base 31 varies with a negative gradient with respect to the frequency. This variation serves to offset the variation in the wavelength according to the frequency. Hence, it is possible to increase the frequency bandwidth in which the antenna 30 can operate, and is possible to suppress the enlargement of the antenna 30.

In the foregoing, the present invention is explained in detail with reference to its embodiments. However, the present invention is not restricted to the above-mentioned embodiments. The present invention can be modified in various manners within the scope not deviating from its gist.

The antenna according to the present invention is not limited to the printed dipole antenna or patch antenna of the embodiments, and may be any other antennas having a base and a conductor in contact with the base. Although an antenna element is provided on the surface of the base in the embodiments, the antenna element may instead be provided inside the base.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims

What is claimed is:

1. An antenna comprising:
a base having a relative permittivity and a relative permeability; and
a first antenna element in contact with the base, the first antenna element being adapted to transmit or receive a radio wave having a frequency,
a product of the relative permittivity and the relative permeability varying with a negative gradient with respect to the frequency of the radio wave.

2. The antenna according to claim 1, wherein the product of the relative permittivity and the relative permeability is inversely proportional to a square of the frequency.

3. The antenna according to claim 1, wherein the base includes a plate having an upper face and a lower face, and the first antenna element has a conductor film provided on the upper face,
the antenna further comprising a second antenna element having another conductor film in contact with the lower face, the antenna operating as a dipole antenna.

4. The antenna according to claim 1, wherein the base includes a plate having an upper face and a lower face, and the first antenna element has a conductor film provided on the upper face,
the antenna further comprising a grounding conductor in contact with the lower face, the antenna operating as a patch antenna.
